(19) United States
(12) Patent Application Publication
(10) Pub. No.: US 2026/0201730 A1
(43) Pub. Date: Jul. 16, 2026

(54) 1615 S Royal Palm Rd

(71) Applicant: Shannon Cooper, Apache Junction, AZ (US)

(72) Inventor: Shannon Cooper, Apache Junction, AZ (US)

(21) Appl. No.: 19/021,438

(22) Filed: Jan. 15, 2025

(51) Int. Cl. E05B 1/00; E06B 5/02

(52) U.S. Cl. CPC E05B 1/0015

(57) ABSTRACT

A handle assembly to be installed in a panel includes a handle unit and a reinforcement plate. The handle unit is to be inserted into an opening in a panel. The handle unit includes a support plate, side walls, a back wall, a flange, and locking tabs. The support plate is designed to be positioned abutting a first surface of a panel. A flange extends from the support plate across a portion of the aperture. The locking tabs extend perpendicularly from the second side of the support plate and adjacent the side walls. Each of the locking tabs includes a projection designed to engage a second surface of a panel to releasably lock the handle unit therein. The reinforcement plate is designed to be positioned between the projection of each of the locking tabs and a second surface of a panel.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to handles for scuttle attic cover panels and more particularly pertains to a new handle assembly for installation in a panel, such as a scuttle attic cover panel. Scuttle attics are attics with a portal or opening in a ceiling of a room and the floor of the attic. In some versions, a staircase is built into the scuttle attic, and the cover panel is hinged and can be pulled down to access the staircase. In other more common versions, the scuttle attic cover panel is simply a flat panel resting in the lip of the opening. The cover panels are usually made of wood, particle board, drywall, MDF, or other building materials. To access the attic, a user pushes on the cover panel from below. As a result, fingerprints and dirt marks are made on the cover panel, leaving unsightly marks. In addition, it can be difficult to open the cover panel in this manner, especially if the user is on a step ladder or similar. Some cover panels include handles screwed directly into the cover panel, but these are unsightly and can easily pull out of the cover panel material. The new handle assembly provides a secure connection that makes it easier to move the cover panel, as well as be aesthetically pleasing.

### (2) Description of Related Art Including Information Disclosed Under 37 CFR 1.97 and 1.98.

The prior art relates to handles for scuttle attic cover panels. The prior art, as best understood, does not disclose a handle assembly to be installed in a panel includes a handle unit and a reinforcement plate, which handle unit has a support plate for stability, a flange for gripping, and locking tabs to releasably lock the handle unit in the panel. The reinforcement plate is designed to be positioned between the locking tabs and a panel.

### BRIEF SUMMARY OF THE INVENTION

An embodiment of the disclosure meets the needs presented above in a handle assembly generally comprising a handle unit and a reinforcement plate. The handle unit is designed to be inserted into a corresponding opening in a panel. The handle unit includes a support plate, side walls, a back wall, a flange, and locking tabs. The support plate includes a first side, a second side, and an aperture therein. The support plate is designed to be positioned with the second side abutting a first surface of a panel. The side walls extend from the second side of the support plate about a perimeter of the aperture. The back wall extends perpendicularly from and connects the side walls. A flange extends from the support plate across a portion of the aperture. The flange is designed to be manually gripped by a user to permit lifting of a panel from the first side of the support plate. The locking tabs extend perpendicularly from the second side of the support plate and adjacent the side walls. Each of the locking tabs includes a projection designed to engage a second surface of a panel to releasably lock the handle unit therein. The reinforcement plate is designed to be positioned between the projection of each of the locking tabs and a second surface of a panel.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a handle assembly according to an embodiment of the disclosure.

FIG. 2 is a bottom perspective view of an embodiment of the disclosure.

FIG. 3 is a top view of a template for use with an embodiment of the disclosure.

FIG. 4 is a side view of an embodiment of the disclosure in use.

FIG. 5 is a bottom view of an embodiment of the disclosure in use.

FIG. 6 is a top view of an embodiment of the disclosure.

FIG. 7 is a front view of an embodiment of the disclosure.

FIG. 8 is a side view of an embodiment of the disclosure.

### DETAILED DESCRIPTION OF THE INVENTION

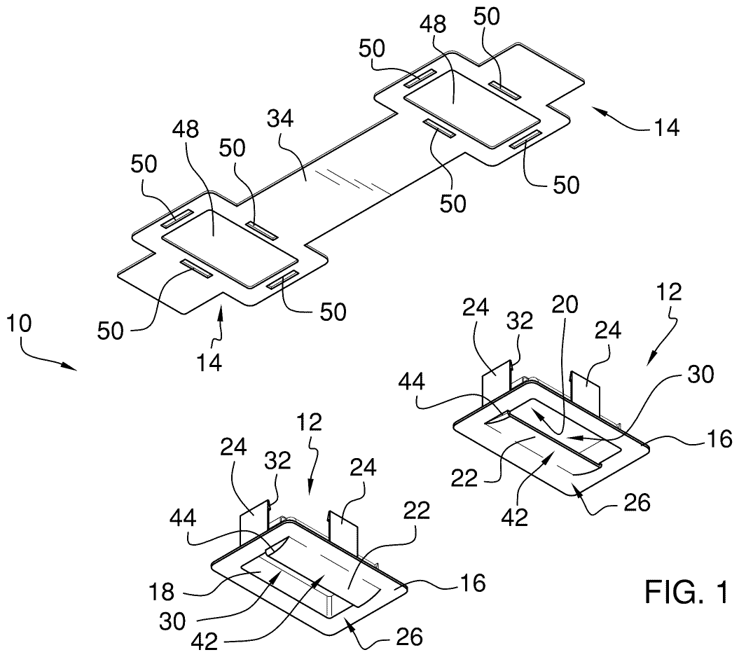

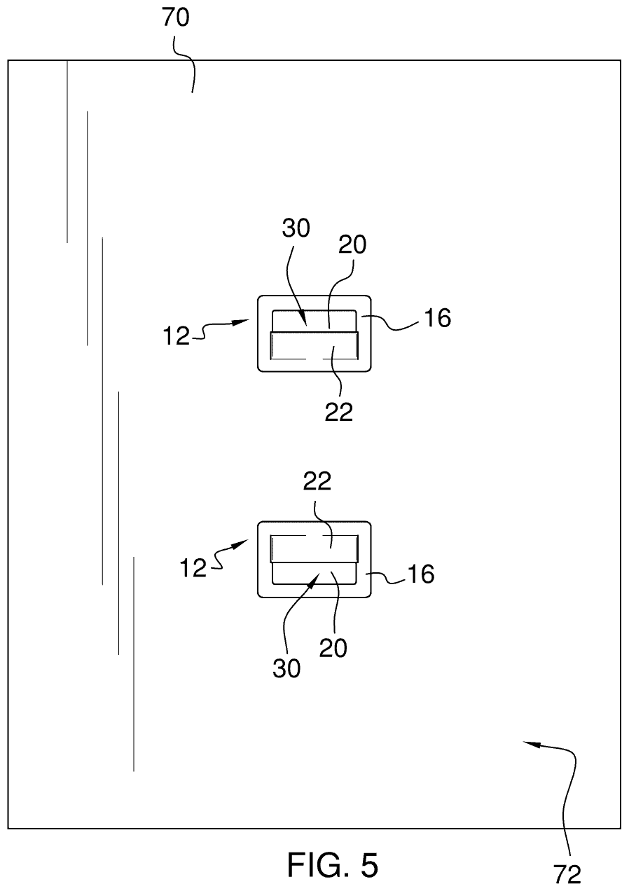

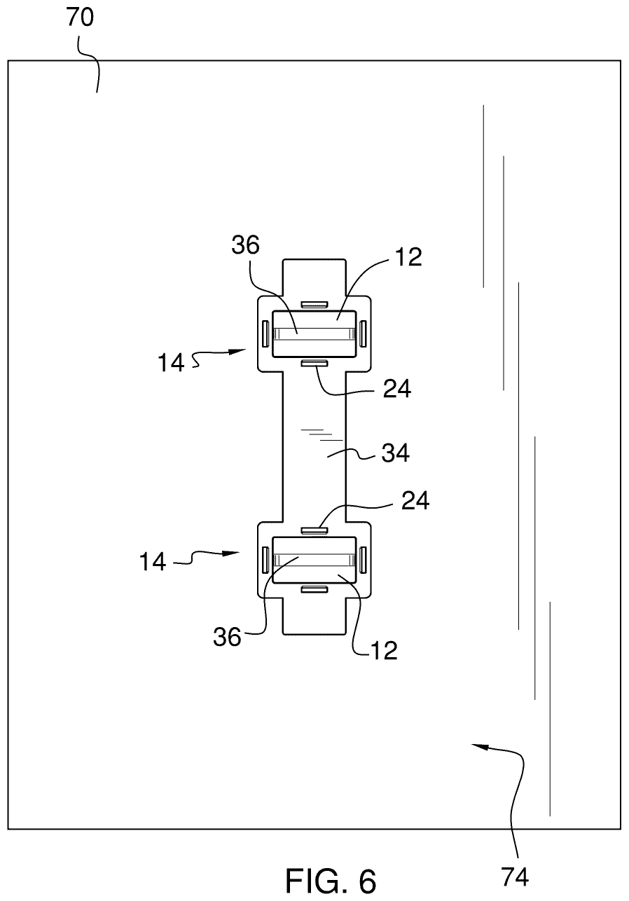

With reference now to the drawings, and in particular to FIGS. 1 through 8 thereof, a new handle assembly embodying the principles and concepts of an embodiment of the disclosure and generally designated by the reference numeral 10 will be described. Where not necessary for understanding of the invention, reference numerals for identical components are not repeated in each figure.

As best illustrated in FIGS. 1 through 8, the handle assembly 10 generally comprises a handle unit 12 and a reinforcement plate 14. The handle unit 12 is designed to be inserted into a corresponding opening in a panel 70. With reference to FIGS. 1, 2, 7 and 8, the handle unit 12 includes a support plate 16, side walls 18, a back wall 20, a flange 22, and locking tabs 24. The support plate 16 includes a first side 26, a second side 28, and an aperture 30 therein. The support plate 16 is designed to be positioned with the second side 28 abutting a first surface 72 of a panel 70. The side walls 18 extend from the second side 28 of the support plate 16 about a perimeter of the aperture 30. The back wall 20 extends perpendicularly from and connects the side walls 18. The flange 22 extends from the support plate 16 across a portion of the aperture 30. The flange 22 is designed to be manually gripped by a user to permit lifting of a panel 70 from the first side 26 of the support plate 16. The locking tabs 24 extend perpendicularly from the second side 28 of the support plate 16 and adjacent the side walls 18. Each of the locking tabs 24 includes a projection 32 designed to engage a second surface 74 of a panel 70 to releasably lock the handle unit 12 therein. The reinforcement plate 14 is designed to be positioned between the projection 32 of each of the locking tabs 24 and a second surface 74 of a panel 70.

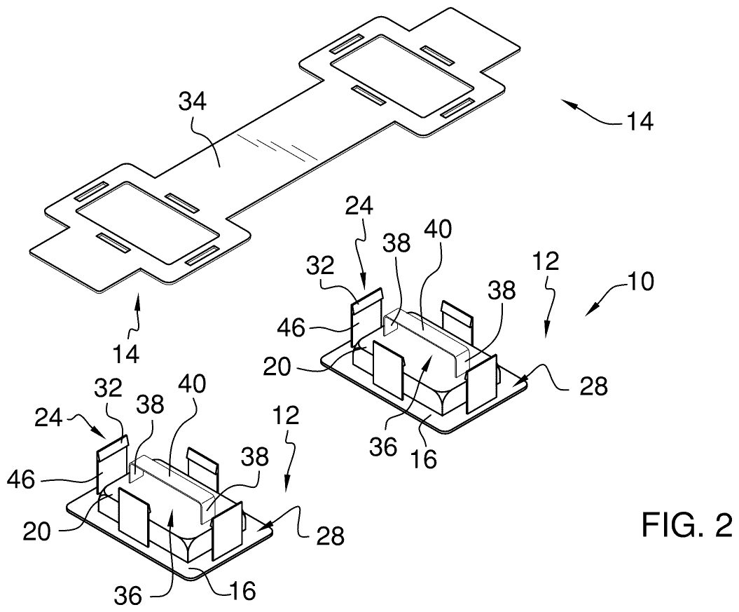

The handle unit 12 is designed to be installed in a scuttle attic cover panel, though the handle unit 12 could be utilized in a variety of panels that provide access through openings but do not have handles or gripping areas. In the exemplary embodiment shown in the figures, the handle unit 12 is one of a pair of handle units 12. It is possible to use only one handle unit 12, though two handle units 12 permit lifting of a panel 70 with two hands, which may be easier to do. In the embodiment with two handle units 12 as shown, the reinforcement plate 14 is one of a pair of the reinforcement plates 14. As shown in FIGS. 1 and 2, each of the pair of reinforcement plates 14 is designed to engage with a corresponding one of the pair of handle units 12. The pair of the reinforcement plates 14 are joined by a connecting piece 34 to form a one-piece structure, though they could be separated.

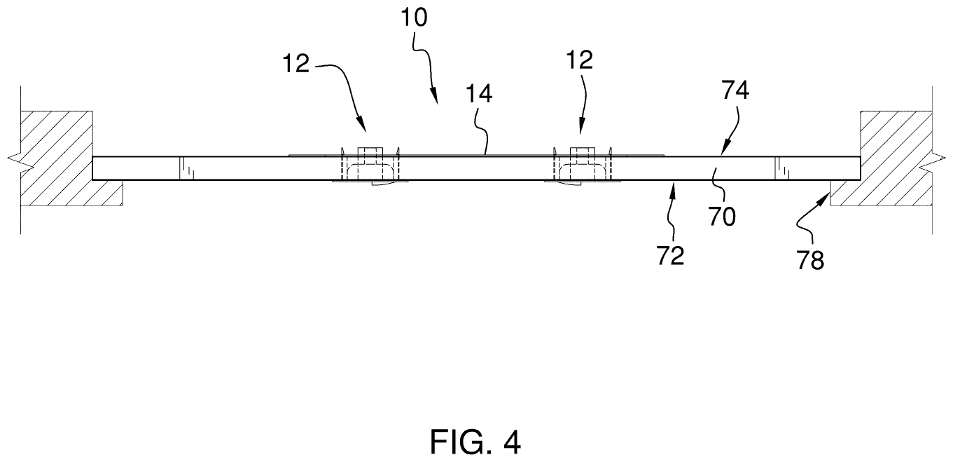

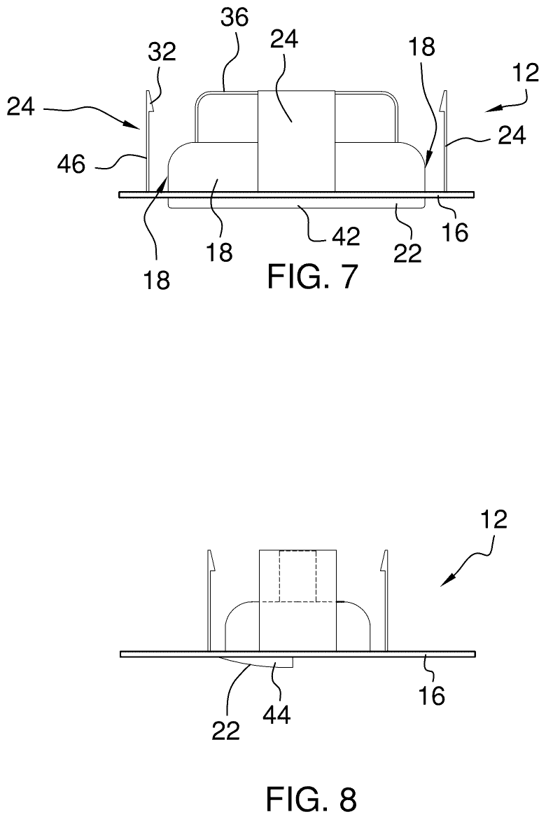

In the exemplary embodiment shown in FIGS. 7 and 8, a handle 36 is positioned on the back wall 20 and projecting away from the second side 28 of the support plate 16. The handle 36 is designed to be manually gripped by a user to permit lifting of a panel 70 from the second side 28 of the support plate 16. The handle 36 includes two arms 38 projecting from the back wall 20 and a crosspiece 40 connecting the two arms 38. The two arms 38 of the handle 36 are designed to support the crosspiece 40 at a height essentially similar to a height of the locking tabs 24, such that the handle 36 projects beyond a second surface 74 of a panel 70 when the handle unit 12 is installed, as shown in FIG. 4. Other designs of the handle 36, such as a T-shaped handle or a knob, are within the scope of the disclosure.

The flange 22 projects outwardly beyond the first side 26 of the support plate 16. The flange 22 includes a top portion 42 that has a convex curvature, and side portions 44 extending from the top portion 42 to the first side 26 of the support plate 16. The design of the flange 22 is to project out to permit additional space for insertion of the fingers of a user when gripping the flange 22, but be substantially flat to present a visually smooth surface that is aesthetically pleasing.

Each of the locking tabs 24 is a snap-fit structure, wherein the projection 32 is positioned at a distal end of a resiliently flexible arm 46. The side walls 18 are shorter than the locking tabs 24 such that the side walls 18 and the back wall 20 do not project beyond a second surface 74 of a panel 70 when the handle unit 12 is installed, as shown in FIG. 4.

The reinforcement plate 14 includes a central aperture 48 to permit access to the handle unit 12. The reinforcement plate 14 includes side apertures 50 positioned about the central aperture 48, wherein each of the locking tabs 24 is designed to be inserted through a corresponding one of the side apertures 50.

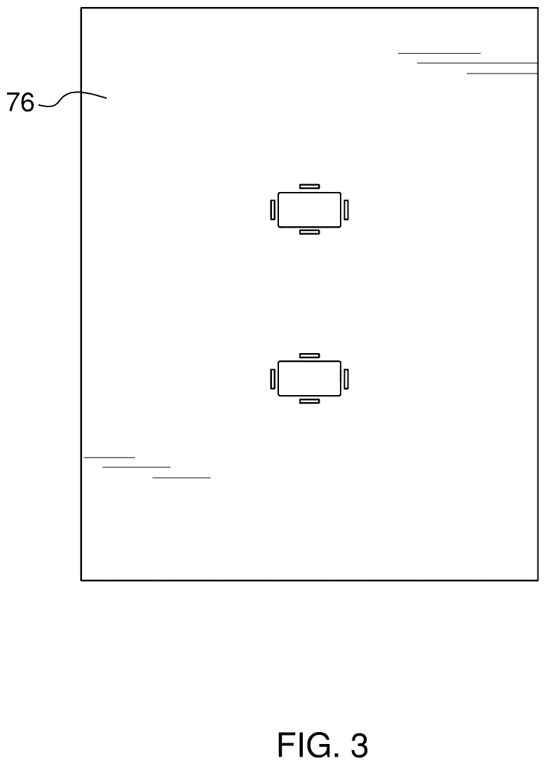

FIGS. 4, 5, and 6 show the handle assembly 10 installed in a panel 70. In this example, the panel 70 is a scuttle attic cover to cover a scuttle attic opening 78. The panel 70 includes a first surface 72 to face away from an attic space and a second surface 74 to face toward an attic space. The handle assembly 10 can be manufactured as part of a scuttle attic cover assembly, or can be manufactured by itself for installation or retrofitting in an existing panel 70. For retrofitting, a template 76, such as a paper or plastic template, shown in FIG. 3, can be used to mark openings to be cut in the panel 70 to match the components of each handle unit 12. Once installed, a user can lift the panel 70 from below, that is, from the room or hallway side, by inserting his or her fingers through the aperture 30 and behind the flange 22. The user can press his or her knuckles against the back wall 20 of the handle unit 12 to push the panel 70 upwardly and into the attic. Once the user has climbed into the attic, the user can use the handle 36 on the back wall 20 of the handle unit 12 to lift the panel 70 from above, such as to move the panel 70 to a position out of the way from the user or possibly back into the scuttle attic opening to cover the scuttle attic opening 78.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A handle assembly to be installed in a panel comprising:
a handle unit being configured to be inserted into a corresponding opening in a panel, said handle unit including:
a support plate having a first side, a second side, and an aperture therein, said support plate being configured to be positioned with said second side abutting a first surface of a panel,
side walls extending from said second side of said support plate about a perimeter of said aperture,
a back wall extending perpendicularly from and connecting said side walls,
a flange extending from said support plate across a portion of said aperture, said flange being configured to be manually gripped by a user to permit lifting of a panel from said first side of said support plate,
locking tabs extending perpendicularly from said second side of said support plate and adjacent said side walls, each of said locking tabs including a projection configured to engage a second surface of a panel to releasably lock said handle unit therein; and
a reinforcement plate being configured to be positioned between said projection of each of said locking tabs and a second surface of a panel.

2. The handle assembly of claim 1, further comprising a handle being disposed on said back wall and projecting away from said second side of said support plate, said handle being configured to be manually gripped by a user to permit lifting of a panel from said second side of said support plate.

3. The handle assembly of claim 2, wherein said handle includes:
two arms projecting from said back wall; and
a crosspiece connecting said two arms.

4. The handle assembly of claim 3, wherein said two arms of said handle are configured to support said crosspiece at a height essentially similar to a height of said locking tabs, such that said handle projects beyond a second surface of a panel when said handle unit is installed.

5. The handle assembly of claim 1, wherein said flange projects outwardly beyond said first side of said support plate.

6. The handle assembly of claim 5, wherein said flange includes:
a top portion having a convex curvature; and
side portions extending from said top portion to said first side of said support plate.

7. The handle assembly of claim 1, wherein each of said locking tabs is a snap-fit structure, wherein said projection is disposed at a distal end of a resiliently flexible arm.

8. The handle assembly of claim 1, wherein said side walls are shorter than said locking tabs such that said side walls and said back wall do not project beyond a second surface of a panel when said handle unit is installed.

9. The handle assembly of claim 1, wherein said reinforcement plate includes a central aperture to permit access to said handle unit.

10. The handle assembly of claim 9, wherein said reinforcement plate includes side apertures disposed about said central aperture, wherein each of said locking tabs is configured to be inserted through a corresponding one of said side apertures.

11. The handle assembly of claim 1, wherein:
the handle assembly further comprises a handle being disposed on said back wall and projecting away from said second side of said support plate, said handle being configured to be manually gripped by a user to permit lifting of a panel from said second side of said support plate;
said handle includes:
two arms projecting from said back wall; and
a crosspiece connecting said two arms;
said two arms of said handle are configured to support said crosspiece at a height essentially similar to a height of said locking tabs, such that said handle projects beyond a second surface of a panel when said handle unit is installed;
said flange projects outwardly beyond said first side of said support plate;
said flange includes:
a top portion having a convex curvature; and
side portions extending from said top portion to said first side of said support plate;
each of said locking tabs is a snap-fit structure, wherein said projection is disposed at a distal end of a resiliently flexible arm;
said side walls are shorter than said locking tabs such that said side walls and said back wall do not project beyond a second surface of a panel when said handle unit is installed;
said reinforcement plate includes a central aperture to permit access to said handle unit;
said reinforcement plate includes side apertures disposed about said central aperture, wherein each of said locking tabs is configured to be inserted through a corresponding one of said side apertures.

12. The handle assembly of claim 11, wherein:
said handle unit is one of a pair of handle units to permit lifting of a panel with two hands; and
said reinforcement plate is one of a pair of said reinforcement plates, each of said pair of reinforcement plates is configured to engage with a corresponding one of said pair of handle units.

13. The handle assembly of claim 12, wherein said pair of said reinforcement plates are joined by a connecting piece to form a one-piece structure.

14. The handle assembly of claim 1, wherein:
said handle unit is one of a pair of handle units to permit lifting of a panel with two hands; and
said reinforcement plate is one of a pair of said reinforcement plates, each of said pair of reinforcement plates is configured to engage with a corresponding one of said pair of handle units.

15. The handle assembly of claim 14, wherein said pair of said reinforcement plates are joined by a connecting piece to form a one-piece structure.

16. A scuttle attic cover assembly comprising:
a panel to cover a scuttle attic opening, said panel having a first surface to face away from an attic space and a second surface to face toward an attic space;
a handle unit being inserted in a corresponding opening in said panel, said handle unit including:
a support plate having a first side, a second side, and an aperture therein, said support plate being positioned with said second side abutting a first surface of said panel,
side walls extending from said second side of said support plate about a perimeter of said aperture,
a back wall extending perpendicularly from and connecting said side walls,
a flange extending from said support plate across a portion of said aperture, said flange being configured to be manually gripped by a user to permit lifting of said panel from said first side of said support plate,
locking tabs extending perpendicularly from said second side of said support plate and adjacent said side walls, each of said locking tabs including a projection engaging said second surface of said panel to releasably lock said handle unit therein; and
a reinforcement plate being positioned between said projection of each of said locking tabs and said second surface of said panel.

17. The scuttle attic cover assembly of claim 16, wherein:
said handle unit is one of a pair of handle units to permit lifting of said panel with two hands; and
said reinforcement plate is one of a pair of said reinforcement plates, each of said pair of reinforcement plates is engaged with a corresponding one of said pair of handle units.

18. The scuttle attic cover assembly of claim 17, wherein said pair of said reinforcement plates are joined by a connecting piece to form a one-piece structure.
